(19) United States
(12) Patent Application Publication
(10) Pub. No.: US 2006/0067747 A1
(43) Pub. Date: Mar. 30, 2006

(54) Electrophotographic endless belt, process for producing electrophotographic endless belt, and electrophotographic apparatus

(75) Inventors: Hidekazu Matsuda, Numazu-shi (JP); Akihiko Nakazawa, Sunto-gun (JP); Atsushi Tanaka, Susono-shi (JP); Takashi Kusaba, Sunto-gun (JP); Yuji Sakurai, Susono-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/226,241

(22) Filed: Sep. 15, 2005

(30) Foreign Application Priority Data
Sep. 24, 2004 (JP) 2004-277570

(51) Int. Cl. G03G 15/20

(52) U.S. Cl. 399/308; 428/474.4; 428/35.7

(57) ABSTRACT

An electrophotographic endless belt which contains a polyamide resin and an additive A comprising at least one selected from the group consisting of copper(I) iodide, potassium iodide, copper(I) chloride and potassium chloride, and has a volume resistivity of from 1×10⁶ to 1×10¹⁴ Ωcm. Also disclosed are a process for producing the electrophotographic endless belt and an electrophotographic apparatus having the electrophotographic endless belt.

### BACKGROUND OF THE INVENTION

1. Field of the Invention

This invention relates to an electrophotographic endless belt, a process for producing the electrophotographic endless belt, and an electrophotographic apparatus having the electrophotographic endless belt.

2. Related Background Art

Besides drum-shaped members and roller-shaped members, endless-belt-shaped members (electrophotographic endless belts) are sometimes used in transfer material transporting members, intermediate transfer members, electrophotographic photosensitive members, fixing members and so forth used in electrophotographic apparatus such as copying machines and laser beam printers.

In recent years, color (such as full-color) electrophotographic apparatus have been put forward into practical use, and there is an increasing demand for endless-belt-shaped transfer material transporting members (i.e., transfer material transporting belts) or endless-belt-shaped intermediate transfer members (i.e., intermediate transfer belts).

An endless belts composed chiefly of a thermoplastic resin is commonly available as the electrophotographic endless belt. The endless belt composed chiefly of a thermoplastic resin has advantages that it can be produced at a low cost and general-purpose molding or extruding machines can be used.

Of the thermoplastic resin, polyamide resin is a material having a large breaking extension and besides having a high modulus of elasticity. The polyamide resin has such superior properties, and hence the use of the polyamide resin in electrophotographic endless belts has already been proposed (Japanese Patent Applications Laid-open No. 2000-347513, No. 2001-142315, No. 2001-350347, etc.).

The polyamide resin, however, has a disadvantage that it is susceptible to heat at the time of molding or extrusion processing, and tends to deteriorate. Stated specifically, the polyamide resin, when exposed to high temperature, comes to tend to have low molecular weight because its molecular chains come to tend to be cut. Resins, as they have lower (smaller) molecular weight, have tendency to have smaller breaking extension and also have tendency to have lower modulus of elasticity.

Hence, conventional electrophotographic endless belts making use of such polyamide resin have so large a breaking extension that, in spite of the use of the polyamide resin which ought to have a high modulus of elasticity, the endless belts have tended to cause cracking, breaking or creep when used repeatedly.

### SUMMARY OF THE INVENTION

An object of the present invention is provide an electrophotographic endless belt having been kept from causing the cracking, breaking or creep that may occur when used repeatedly, and provide a process for producing the electrophotographic endless belt and an electrophotographic apparatus having the electrophotographic endless belt.

That is, the present invention is an electrophotographic endless belt comprising a polyamide resin and an additive A, wherein the additive A is at least one selected from the group consisting of copper(I) iodide, potassium iodide, copper(I) chloride and potassium chloride, and the electrophotographic endless belt has a volume resistivity of from 1×10⁶ to 1×10¹⁴ Ωcm.

The present invention is also a process for producing an electrophotographic endless belt which comprises a polyamide resin, carbon black and an additive A comprising at least one selected from the group consisting of copper(I) iodide, potassium iodide, copper(I) chloride and potassium chloride, and has a volume resistivity of from 1×10⁶ to 1×10¹⁴ Ωcm; the process comprising the step of mixing the polyamide resin, the carbon black and the additive A before the polyamide resin and the carbon black are compounded.

The present invention is still also an electrophotographic apparatus having an electrophotographic endless belt, the electrophotographic endless belt comprising a polyamide resin and an additive A, wherein the additive A is at least one selected from the group consisting of copper(I) iodide, potassium iodide, copper(I) chloride and potassium chloride, and the electrophotographic endless belt has a volume resistivity of from 1×10⁶ to 1×10¹⁴ Ωcm.

### BRIEF DESCRIPTION OF THE DRAWINGS

FIG. 1 is a schematic view showing an example of the construction of an apparatus for producing the electrophotographic endless belt, which employs blown-film extrusion (inflation).

FIG. 2 is a schematic view showing another example of the construction of an apparatus for producing the electrophotographic endless belt, which employs blown-film extrusion (inflation).

FIG. 3 is a schematic view showing an example of the construction of a twin-screw extruder.

FIG. 4 is a schematic view showing an example of the construction of an intermediate transfer type color electrophotographic apparatus.

FIG. 5 is a schematic view showing an example of the construction of an in-line type color electrophotographic apparatus.

FIG. 6 is a schematic view showing another example of the construction of the intermediate transfer type color electrophotographic apparatus.

FIG. 7 is a schematic view showing the construction of an instrument for measuring electrical properties (leak).

FIG. 8 is a graph showing the results of measurement of electrical properties (leak).

FIG. 9 is a schematic view showing the construction of a flexing tester.

### DESCRIPTION OF THE PREFERRED EMBODIMENTS

The polyamide resin (PA) refers to a high polymer having as a repeating unit an amide linkage (—CONH—) in the molecule, and is also called a nylon resin.

The polyamide resin is a material which has a large breaking extension and besides (i.e., is tough and besides) has a high modulus of elasticity. Hence, it is preferable as a material for electrophotographic endless belts that are required to have durability. In particular, the polyamide resin, though having a high modulus of elasticity and being tough as the whole resin, has flexibility at its surface than any other thermoplastic resins. Hence, the polyamide resin enables soft transfer when it is used in transfer material transporting members or intermediate transfer members among electrophotographic endless belts, and good images can be obtained which have been made to have less blank areas or spots around line images.

The polyamide resin used in the present invention may include, e.g., polyamide 4/6 (PA 46), polyamide 6 (PA 6), polyamide 6/10 (PA. 610), polyamide 6/12 (PA 612), polyamide 6/6 (PA 66), polyamide 6T (PA 6T), polyamide 7 (PA 7), polyamide 8 (PA 8), polyamide 9 (PA 9), polyamide 9T (PA 9T), polyamide 10 (PA 10), polyamide 11 (PA 11), polyamide 12 (PA 12) and polyamide MXD6. Any of these may be used alone or in combination of two or more types. These are also commercialy available with ease.

The polyamide resin is a material which has superior flexing resistance (i.e., can not easily cause cracking or breaking due to flexing). In particular, a crystallizable polyamide resin has especially good flexing resistance. On the other hand, a non-crystallizable polyamide resin has flexing resistance inferior to the crystallizable polyamide resin, but has dimensional stability superior to the crystallizable polyamide resin. Hence, the crystallizable polyamide resin and the non-crystallizable polyamide resin may be used in combination. Also, a copolymer polyamide resin may also be used which is synthesized using some kinds of monomers.

In the present invention, from the viewpoint of mechanical strength and moldability or extrudability, the polyamide resin may preferably have molecular weight in the range of from 5,000 to 50,000 as number-average molecular weight. The larger molecular weight it has, the higher mechanical strength it tends to have, and the smaller molecular weight it has, the higher moldability or extrudability it tends to have.

The type of the polyamide resin used may also appropriately be selected in accordance with properties to be required. For example, a polyamide resin having amide groups in a small proportion (such as polyamide 11 and polyamide 12) may be used in order to make the influence of water content smaller, and a polyamide resin having amide groups in a large proportion or a polyamide resin haveing a benzene ring in the backbone chain may be used when a higher modulus of elasticity is required.

As stated above, the polyamide resin is a good material as a material used in the electrophotographic endless belt, but on the other hand has a disadvantage that it tends to cause deterioration due to heat at the time of molding or extrusion processing.

The electrophotographic endless belt may preferably have, as described later, a volume resistivity of from 1×10⁶ to 1×10¹⁴ Ωcm. The electrophotographic endless belt of the present invention is that which has volume resistivity in that preferable range.

The polyamide resin itself has too high volume resistivity, and hence it is difficult to produce the above preferable electrophotographic endless belt by using only the polyamide resin. To control the volume resistivity, it is preferable to use a conducting agent in combination. Also, as the conducting agent, a particulate conducting agent is preferred in view of an advantage that the resistivity is controllable with ease and a stable volume resistivity is achievable. In particular, carbon black is more preferred.

However, in the case when the particulate conducting agent such as carbon black is used, i.e., in the case when a resin composition prepared by mixing the particulate conducting agent in the polyamide resin is molded or extruded to produce an endless belt, the resin composition has a tendency to have a higher temperature at the time of molding or extrusion processing, than a case in which the particulate conducting agent such as carbon black is not used in combination. Hence, the polyamide-resin may remarkably deteriorate because of heat.

To the electrophotographic endless belt, a filler(s) of various types other than the particulate conducting agent such as carbon black may also be added for the purpose of reducing cost, improving physical properties, providing function, improving processability, and so forth. Where such a filler(s) is/are used, too, the polyamide resin may still remarkably deteriorate because of heat.

More specifically, where a resin composition prepared by mixing the particulate conducting agent (such as carbon black) and other filler(s) of various types in the polyamide resin is processed by molding or extrusion to produce an electrophotographic endless belt, the resin composition has a higher viscosity as the particulate conducting agent (such as carbon black) and other filler(s) of various types are in a larger content in the resin composition. If the resin composition has a high viscosity, the resin composition comes to have a higher temperature than the initially preset temperature (the temperature preset at the time of molding or extrusion processing), because of the shearing heat generation that comes about while the resin composition is kneaded with a kneader or the like.

As a method for controlling such shearing heat generation, a method is available in which the preset temperature is made higher and the resin composition is made to have a low viscosity. However, making the preset temperature higher makes the resin composition have a higher temperature. On the contrary, making the preset temperature lower makes the resin composition have a higher viscosity, and hence a great shearing heat generation may result, still making the resin composition come to have a higher temperature.

In order to keep the polyamide resin from deteriorating because of heat as stated above, in producing the electrophotographic endless belt of the present invention, an additive A is used which comprises at least one selected from the group consisting of copper(I) iodide, potassium iodide, copper(I) chloride and potassium chloride.

Incidentally, in the present invention, the additive which comprises at least one selected from the group consisting of copper(I) iodide, potassium iodide, copper(I) chloride and potassium chloride is called “additive A” in order to distinguish it from any other additive(s). The “additive A” does not include any compound(s) other than the copper(I) iodide, potassium iodide, copper(I) chloride and potassium chloride. Also, the “additive A” may consist of any one of copper(I) iodide, potassium iodide, copper(I) chloride and potassium chloride, or may consist of any two of them, or may consist of any three of them, or may consist of four of them.

The deterioration of the polyamide resin because of heat, i.e., making the polyamide resin have a low molecular weight may also not only cause a lowering of the breaking extension and modulus of elasticity of the electrophotographic endless belt to be produced, but also cause a lowering of the dispersibility of the particulate conducting agent (such as carbon black) and other filler(s) of various types when they are used in combination, so that the electrophotographic endless belt to be obtained may inevitably come into one having many leak points.

Also where the electrophotographic endless belt is produced using the particulate conducting agent (such as carbon black) and other filler(s) of various types in combination, the use of the additive A enables production of an electrophotographic endless belt having only few leak points.

Details of how the additive A acts on the effect of keeping the polyamide resin from deteriorating because of heat are unclear. The present inventors presume that copper ions or potassium ions in the copper(I) iodide, potassium iodide, copper(I) chloride or potassium chloride coordinate with the amide group of the polyamide resin, and this makes the polyamide resin not easily affected by heat.

As a result of studies made by the present inventors, it has also been found that, where the electrophotographic endless belt is produced using the polyamide resin and the additive A, the present invention has also an effect other than the effect of keeping the polyamide resin from deteriorating because of heat.

That is, if an electrophotographic endless belt is produced using the polyamide resin and without use of the additive A, the polyamide resin undergoes partial gelation. It has come about that such gelation appears as pimples on the surface of the thin-wall-shaped endless belt, and consequently causes defects on images reproduced. Also, even if it does not appear as pimples on the surface of the endless belt, it has come about that the endless belt may have non-uniform portions in its interior, where abnormal charging may take place from such portions as starting points to consequently causes defects on images reproduced.

However, it has been found that such pimples (non-uniform portions) are reduced when the electrophotographic endless belt is produced using the polyamide resin and the additive A in combination.

The copper(I) iodide, potassium iodide, copper(I) chloride and potassium chloride are commercially available with ease.

The additive A in the electrophotographic endless belt of the present invention may preferably be in a content of from 0.01 to 1% by weight based on the total weight of the polyamide resin and additive A. If the additive A is in a too small content, the product has a tendency to poorly enjoy the effect of the present invention. If it is in a too large content, the electrophotographic endless belt may have a low mechanical strength, or its volume resistivity may come outside the above preferable range.

In the case when the conducting agent is used in the electrophotographic endless belt, as mentioned previously a particulate conducting agent is preferred in view of the advantage that the resistivity is controllable with ease and a stable volume resistivity is achievable, and, in particular, carbon black is more preferred.

The particulate conducting agent such as carbon black has, as being different from organic antistatic agents or electrolytes, an advantage that its resistance can not easily vary because of temperature and humidity. Also, it has less possibility of bleeding out to the surface of the electrophotographic endless belt. Still also, it has a reinforcing effect on the polyamide resin which is a binder resin, and hence has the effect of improving rupture resistance and creep resistance of the electrophotographic endless belt.

The carbon black may include furnace black, thermal black, gas black, acetylene black and KETJEN BLACK. Carbon black for coloring may also sufficiently function as the conducting agent.

The above carbon black is commercially available with ease. For example, it may include, as acetylene black, DENKA BLACK (powdery products, granular products, pressed products, HS-100, etc.), available from Denki Kagaku Kogyo Kabushiki Kaisha; KETJEN BLACK (EC, EC600JD), available from Lion Corporation; COLOR BLACK, SPECIAL BLACK, PRINTEX, HI BLACK and LAMP BLACK, available from Deggusa Corp.; RAVEN, available from Columbian Carbon; VULCAN, MONARCH, REGAL, BLACK PEARLS and MOGUL, available from Cabot Corp.; ASAHI CARBON, available from Asahi Carbon Co., Ltd.; and TOKA BLACK, available from Tokai Carbon Co., Ltd.

The carbon black may preferably be in a content of 2% by weight or more based on the total weight of the electrophotographic endless belt, from the viewpoint of resistance control of the electrophotographic endless belt and also from the viewpoint of improvement of rupture resistance and creep resistance of the electrophotographic endless belt. On the other hand, the carbon black may preferably be in a content of less than 40% by weight based on the total weight of the electrophotographic endless belt, because the electrophotographic endless belt has a tendency to have a higher brittleness and a lower flexing resistance as the carbon black is in a larger content.

A conducting agent other than the carbon black may also be used in the electrophotographic endless belt of the present invention. Such a conducting agent other than the carbon black may include a resin containing a polyether unit and a salt having a perfluoroalkyl group, having a volume resistivity of 10¹⁰ Ωcm or less.

In the electrophotographic endless belt of the present invention, the carbon black and the conducting agent other than the carbon black may be used in combination.

As a method for incorporating the electrophotographic endless belt with the carbon black in the stated quantity, from the viewpoint of improving the dispersibility of the carbon black, what is called a master batch method is preferred in which a resin composition containing a polyamide resin previously incorporated with the carbon black in a high concentration is prepared and this is diluted to make the carbon black contained in the stated quantity.

The electrophotographic endless belt may preferably have, as stated above, a volume resistivity of from 1×10⁶ to 1×10¹⁴ Ωcm.

If the electrophotographic endless belt has a too low volume resistivity where the electrophotographic endless belt is used as a transfer material transporting member, the ability to make a transfer material attracted surely to the electrophotographic endless belt to transport the transfer material at a constant speed may lower in a high-temperature and high-humidity environment to tend to cause color misregistration seriously.

If the electrophotographic endless belt has a too low volume resistivity where the electrophotographic endless belt is used as an intermediate transfer member, thrust-through images (images in which areas with a low density have partially come about) tend to occur. This is considered due to the fact that, in the case of the intermediate transfer member, the toner is directly transferred thereto not via paper and hence the intermediate transfer member tends to be influenced by having a low resistance, where the voltage applied to a transfer nip increases to cause abnormal discharge to make it difficult for the toner to be sufficiently transferred from an electrophotographic photosensitive member.

If on the other hand the electrophotographic endless belt has a too high volume resistivity where the electrophotographic endless belt is used as a transfer member such as the transfer material transporting member or the intermediate transfer member, the transfer electric current may come to flow with difficulty. If it comes, a transfer electric current is required which is high correspondingly thereto, and hence abnormal discharge tends to occur at the time of transfer to tend to cause faults in images reproduced. Also, a large power source is required in order to attain the electric current necessary for transfer, and this may invite large-sized electrophotographic apparatus and high power consumption.

To the electrophotographic endless belt of the present invention, as mentioned previously, a filler(s) may be added for the purpose of reducing cost, improving physical properties, providing function, improving processability, and so forth. As the filler(s), usable are, e.g., any of calcium carbonate, talc, kaolin, clay, silica, mica, wollastonite, and potassium titanate, as well as other metal oxides, metal hydroxides, metal carbonates, metal silicates and so forth.

The addition of such a filler having a small water absorption is also effective in lowering the water absorption of the electrophotographic endless belt making use of the polyamide resin. As a result of the lowering of water absorption, the resistance of the electrophotographic endless belt can less vary depending on environment, and this enables formation of good images in either of low-temperature and low-humidity environment and high-temperature and high-humidity environment.

Where the filler is used in the electrophotographic endless belt, the filler may preferably have a particle diameter (an average of maximum diameter and minimum diameter) of from 0.01 μm to 5 μm. If it has a too small particle diameter, the filler may scatter to make operability poor, making it difficult to effect uniform dispersion. If it has a too large particle diameter, the effect to be brought by the use of the filler may be obtained with difficulty, and also such a filler may appear as pimples on the electrophotographic endless belt surface.

The particle shape of the filler may include a granular shape (spherical, or amorphous), a platelike shape and a fibrous shape (acicular).

Where the particulate conducting agent (such as carbon black) and other filler of various types are used in the electrophotographic endless belt, the particulate conducting agent (such as carbon black) and other filler of various types may preferably be in an amount of less than 40% by weight in total, based on the total weight of the electrophotographic endless belt, from the viewpoint of controlling brittleness of the electrophotographic endless belt.

For the purpose of improving moldability or extrudability and modifying resin properties, a reactive polyolefin, a modified polyolefin or a thermoplastic elastomer, having reactivity to the polyamide resin, may also be added to the electrophotographic endless belt of the present invention.

In general, the polyamide resin may undergo great changes in melt viscosity in respect to temperature, and, where extrusion or the like is carried out to produce the electrophotographic endless belt, the polyamide resin has a narrow temperature range in which it can stably be extruded. In order to carry out the extrusion stably even when the temperature rises or falls to a certain extent, it is preferable to use the polyamide resin and a modified polyolefin in combination.

This modified polyolefin is meant to be a polyolefin (polyethylene, polypropylene or the like) into the molecular chain of which a functional group having reactivity (e.g., an epoxy group, a maleic anhydride group or an oxazoline group) has been introduced.

Such a modified polyolefin may include, e.g., epoxy-group-containing olefin copolymers, an ethylene/glycidyl methacrylate copolymer, a maleic anhydride/ethylene copolymer, an ethylene/vinyl acetate/glycidyl methacrylate terpolymer, an ethylene/ethyl acrylate/glycidyl methacrylate terpolymer, an ethylene/glycidyl acrylate copolymer, an ethylene/vinyl acetate/glycidyl acrylate terpolymer and an ethylene/acrylate/maleic anhydride terpolymer.

Such a modified polyolefin is commercially available with ease. It may include, e.g., BOND FAST, available from Sumitomo Chemical Co., Ltd.; BONDYNE, available from Sumitomo Atofina Co., Ltd.; RESK PEARL, and ADOTEX, available from Nippon Polyethylene Co., Ltd.; MODIPER, available from Nippon Oil & Fats Co., Ltd.; and YOUMEX, available from Sanyo Chemical Industries, Ltd.

Of the above modified polyolefin, a modified polyethylene has superior non-adherence properties compared with the polyamide resin, and has the effects of making toner having scattered inside the electrophotographic apparatus less adhere to the back of the electrophotographic endless belt, and improving cleaning performance for toner having adhered to the surface of the electrophotographic endless belt.

In general, the modified polyolefin has a lower modulus of elasticity than the polyamide resin, where the modulus of elasticity of the electrophotographic endless belt tends to decrease with an increase in the amount of the modified polyolefin added to the electrophotographic endless belt. Accordingly, the modified polyolefin in the electrophotographic endless belt may preferably be in a content of less than 50% by weight based on the weight of the polyamide resin in the electrophotographic endless belt.

For the purpose of improving various properties, the electrophotographic endless belt of the present invention may also be incorporated with a thermoplastic elastomer. The thermoplastic elastomer may be one having conductivity, or may be one having no conductivity.

The thermoplastic elastomer may include, e.g., polyolefin type elastomers, polystyrene type elastomers, polyamide type elastomers, polyester type elastomers, hydrogenated SBS type elastomers and polyurethane type elastomers.

However, in the case of the thermoplastic elastomer as well, the modulus of elasticity of the electrophotographic endless belt tends to decrease with an increase in the amount of the thermoplastic elastomer added to the electrophotographic endless belt, and this may promote the creep of the electrophotographic endless belt. Accordingly, it may preferably be in an amount of less than 50% by weight based on the weight of the polyamide resin.

In order to improve the dispersibility of the additive A, the particulate conducting agent such as carbon black and other filler of various types in the electrophotographic endless belt, a dispersing agent may also be used in the electrophotographic endless belt. The dispersing agent may include, e.g., polyglycerol poly-ricinolate and polyglycerol stearate.

The dispersing agent may be use in carrying out dispersion treatment by a known treating method (such as a wet process or a dry process) by means of a known treating apparatus (such as Henschel mixer or Super mixer).

A flame retardant may also be added to the electrophotographic endless belt of the present invention in order to improve its flame retardant properties. As the flame retardant, melamine and melamine cyanurate, which are triazine compounds, and phosphates are preferred because they bring out an especially remarkable flame retardant effect on the electrophotographic endless belt making use of the polyamide resin.

An antioxidant such as a hindered bisphenol type antioxidant may be added to the electrophotographic endless belt of the present invention.

In addition to the components described above, other component(s) may also be added to the electrophotographic endless belt of the present invention as long as the effect of the present invention is not damaged. Such other component(s) may include, e.g., a processing aid, a lubricant, a release agent, a plasticizer, a colorant, a nucleating agent and an age resistor.

In the present invention, a thermoplastic resin other than the polyamide resin or a thermosetting resin may be used in combination as long as the effect of the present invention is not damaged. It may include, e.g., polyethylene resins such as high-density polyethylene (HDPE), medium-density polyethylene (MDPE), low-density polyethylene (LDPE), linear low-density polyethylene (LLDPE) and ultrahigh-molecular weight polyethylene (UHMW-PE); polyester resins such as polyethylene terephthalate (PET), polybutylene terephthalate (PBT) and polyethylene naphthalate (PEN); polypropylene (PP), polyacetal (POM), polyphenylene sulfide (PPS), liquid-crystal polymer (LCP), polymethylpentene (PMP), polytrimethylene terephthalate (PTT), polycyclohexylene dimethylene terephthalate (PCT), polystyrene (PS), acrylonitrile-styrene resin (AS), polymethyl methacrylate (PMMA), polycarbonate (PC), polyphenylene ether (PPE), styrene methacrylate copolymer (MS), polysulfone (PSF), polyether sulfone (PES), polyarylate (PAR), polyether imide (PEI), polyamide-imide (PAI), thermoplastic polyimide (PI), polyether ether ketone (PEEK), a cycloolefin polymer (COP), a cycloolefin copolymer (COC), polyacrylonitrile (PAN), PET-G [a copolymer of polyethylene terephthalate (PET) and polycyclohexylene dimethylene terephthalate (PCT)], high-impact polystyrene (HIPS), acrylonitrile-styrene-butadiene resin (ABS), methacrylate-butadiene-styrene resin (MBS) and polyacrylonitrile (PAN), as well as copolymers of any of these.

The process for producing the electrophotographic endless belt may include, e.g., extrusion, blown-film extrusion (inflation), injection molding, and blow molding. In particular, blown-film extrusion is preferred.

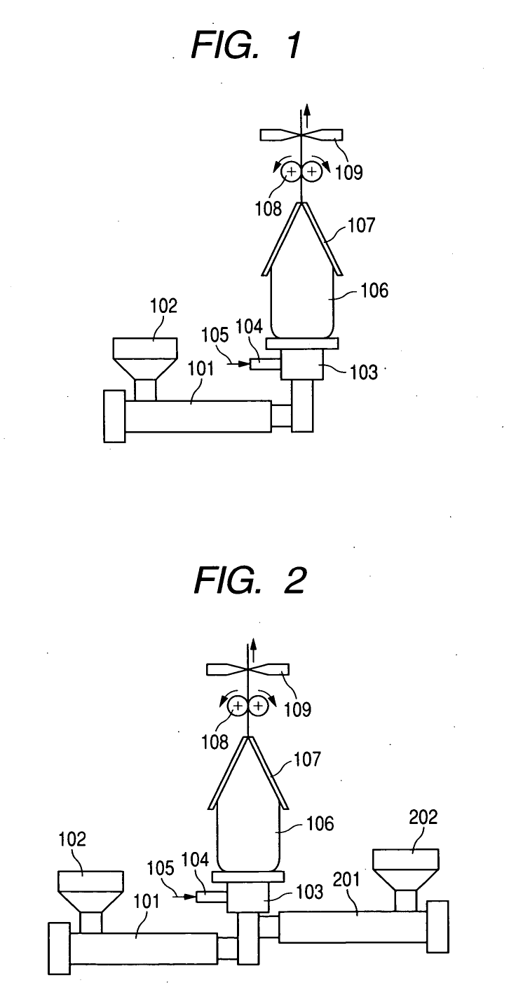

FIG. 1 is a schematic view showing an example of the construction of an apparatus for producing the electrophotographic endless belt, which employs the blown-film extrusion.

First, an extrusion material prepared by premixing the above polyamide resin and additive A and optionally the carbon black and the filler under the stated formulation, followed by kneading and dispersion, is put into an extruder 101 from a hopper 102. Temperature and screw construction in the extruder 101 are so selected that the extrusion material may have a melt viscosity for enabling extrusion into a belt and also the conductive filler is uniformly dispersed in the extrusion material.

The extrusion material is melt-kneaded in the extruder 101 into a melt, which then enters a circular die 103. The circular die 103 is provided with a gas inlet passage 104. Through the gas inlet passage 104, gas 105 such as air is blown into the circular die 103, whereupon the melt having passed through the circular die 103 inflates while scaling up in the diametrical direction. Incidentally, the extrusion may be carried out without blowing the gas 105 into the gas inlet passage 104.

The extruded product (tubular film) 106 having thus inflated is drawn upward while being cooled by cooling rings 108. When it is drawn upward, it passes through the space defined by a dimension stabilizing guide 107, whereby the length in peripheral direction (peripheral length) of the electrophotographic endless belt is fixed, and also it is cut with a cutter 109 in the desired length, whereby the length in generatrix direction (width) of the electrophotographic endless belt is fixed.

Thus, the electrophotographic endless belt can be obtained.

The foregoing description relates to production of an electrophotographic endless belt of single-layer structure. In the case of an electrophotographic endless belt of double-layer structure, a second extruder 201 is additionally provided as shown in FIG. 2 (202 denotes a second hopper). A melt from the extruder 101 and a melt from the extruder 201 are simultaneously sent into a double-layer circular die 103, and the two layers are scale-up inflated simultaneously, thus the electrophotographic endless belt of double-layer structure can be obtained. In the case of triple or more layer structure, the extruder may be provided in the number corresponding to the number of layers.

Incidentally, the electrophotographic endless belt of the present invention may have a joint, or may have no joint. That is, the material may be extruded in the shape of a sheet, and thereafter the sheet may be rolled up, and then joined by ultrasonic welding or the like. Also, the inner form and outer form as described above may be used to obtain the endless belt.

The electrophotographic endless belt of the present invention may preferably have a thickness of from 50 μm to 250 μm. If the electrophotographic endless belt is too thick, it may have a low belt travel performance because of a high rigidity and a poor flexibility to cause deflection or one-sided travel. If on the other hand the electrophotographic endless belt is too thin, it may have a low tensile strength or may cause creep as a result of repetitive use.

Incidentally, before the above blown-film extrusion is carried out, as described above the extrusion material is beforehand obtained by premixing the above polyamide resin and additive A and optionally the carbon black and the filler under the stated formulation, followed by kneading and dispersion.

As a method for obtaining the extrusion material, a method is preferred in which these are kneaded by means of a twin-screw extruder to obtain the extrusion material.

As a method for adding the additive A, it is preferable to beforehand sprinkle the polyamide resin with the additive A, which is then introduced into a twin-screw extruder or the like, or to introduce the polyamide resin and the additive A together into a twin-screw extruder.

Before the particulate conducting agent (such as carbon black) and the filler are introduced into the extruder, the additive A may previously be dispersed in the polyamide resin in the state the polyamide resin has a low viscosity, and then the particulate conducting agent (such as carbon black) and the filler may be introduced into the extruder in the state the additive A has been dispersed in the polyamide resin. This is more preferable because the effect to be brought by the use of the additive A can sufficiently be brought out.

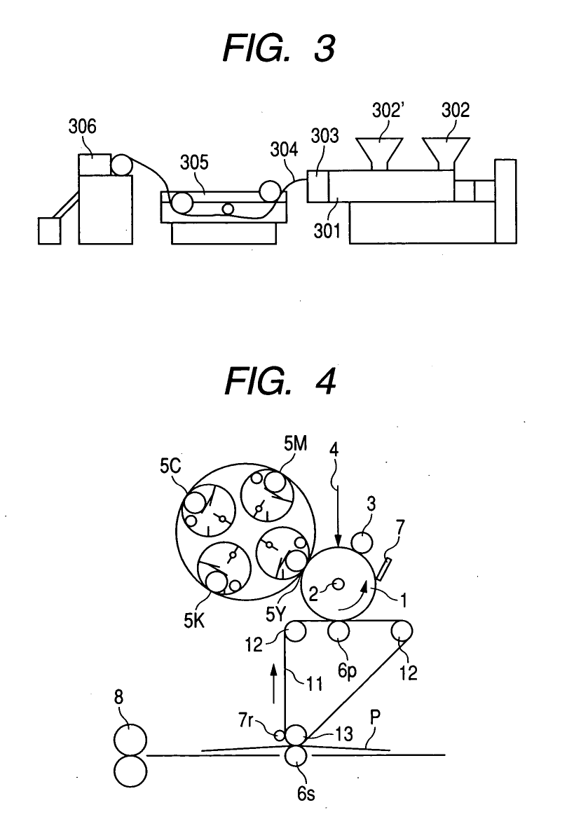

FIG. 3 schematically illustrates an example of the construction of the twin-screw extruder.

It is common that components constituting the extrusion material are introduced at one time from a hopper 302 into a twin-screw extruder 301.

However, the electrophotographic endless belt is required to have a higher precision than commonly available resin extruded products. Also, where the conducting agent such as carbon black is used in combination, a high dispersibility is required in the conducting agent. Hence, a method is preferred in which the polyamide resin is first introduced into the twin-screw extruder 301, and then, at the stage where the polyamide resin has melted, the conducting agent is introduced into the twin-screw extruder 301. The same as the conducting agent applies also when the filler is used. In FIG. 3, reference numeral 3021 also denotes a hopper.

Materials melt-kneaded by the twin-screw extruder are extruded from a strand die 303 in the form of a strand 304, which is then passed through a water bath 305 so as to be cooled, and then passed through a strand cutter 306 to obtain the extrusion material.

The kneading in the twin-screw extruder may be one-time kneading, or what has first been passed through the twin-screw extruder may be kneaded two or more times by means of the twin-screw extruder (two or more time kneading).

The twin-screw extruder may include, e.g., TEX, manufactured by The Japan Steel Works, Ltd. (JSW); TEM, manufactured by Toshiba Machine Co., Ltd.; and PCM, manufactured by Ikegai Corp.

In the blown-film extrusion described above, the extrusion material is beforehand obtained and then extruded in the shape of an endless belt. However, the extrusion material may be extruded in the shape of an endless belt through one step.

At the time of the kneading, it is preferable to carry out the kneading while carrying out displacement with nitrogen, or the like.

The electrophotographic endless belt of the present invention may be constituted of a single layer, or may be constituted of a multiple layer consisting of a plurality of layers.

The electrophotographic endless belt is used in the electrophotographic apparatus usually in the state it is stretched over a plurality of stretch-over rollers. Here, if it is difficult to prevent the electrophotographic endless belt from meandering, because of straightness, shake or the like of the stretch-over rollers, the electrophotographic endless belt may be provided with a meandering preventive member (a rib or the like).

Whether or not the additive A is contained in the electrophotographic endless belt may be analyzed by a method making use of a known instrument such as an atomic-absorption photometer.

FIG. 4 schematically illustrates an example of the construction of a color electrophotographic apparatus of an intermediate transfer system. The transfer of toner images from an electrophotographic photosensitive member to a transfer material is chiefly performed by a primary transfer charging member, an intermediate transfer belt and a secondary transfer charging member.

In FIG. 4, reference numeral 1 denotes a cylindrical electrophotographic photosensitive member, which is rotatingly driven around an axis 2 in the direction of an arrow at a prescribed peripheral speed.

The electrophotographic photosensitive member 1 is uniformly electrostatically charged on its surface to a positive or negative, stated potential through a primary charging member 3. The photosensitive member thus charged is then exposed to exposure light (imagewise exposure light) 4 emitted from an exposure means (not shown) for slit exposure or laser beam scanning exposure. The exposure light used here is exposure light corresponding to a first-color component image (e.g., a yellow component image) of an intended full-color image. Thus, on the surface of the electrophotographic photosensitive member 1, first-color component electrostatic latent images (yellow component electrostatic latent image) are successively formed which correspond to the first-color component image of the intended full-color image.

An intermediate transfer belt 11 stretched over stretch-over rollers 12 and a secondary transfer opposing roller 13 is rotatingly driven in the direction of an arrow at substantially the same peripheral speed as the electrophotographic photosensitive member 1 (e.g., at a speed of 97 to 103% in respect to the peripheral speed of the electrophotographic photosensitive member 1).

The first-color component electrostatic latent images formed on the surface of the electrophotographic photosensitive member 1 are developed with a first-color toner (yellow toner) contained in a developer held by a first-color developer carrying member (yellow developer carrying member) 5Y, to form a first-color toner image (yellow toner image). Then, the first-color toner images formed and held-on the surface of the electrophotographic photosensitive member 1 are successively primarily transferred on to the surface of the intermediate transfer belt 11 passing through between the electrophotographic photosensitive member 1 and a primary transfer charging member (primary transfer charging roller) 6p, by the aid of a primary transfer bias applied from the primary transfer charging member 6p.

The surface of the electrophotographic photosensitive member 1 from which the first-color toner images have been transferred is cleaned by a cleaning member 7 to remove primary transfer residual developer (toner) to make the surface clean. Thereafter, the photosensitive member thus cleaned is used for the next-color image formation.

Second-color toner images (magenta toner images), third-color toner images (cyan toner images) and fourth-color toner images (black toner images) are also transferred to the surface of the electrophotographic photosensitive member 1 and then sequentially primarily transferred to the surface of the intermediate transfer belt 11, in the same manner as the first-color toner images. Thus, synthesized toner images corresponding to the intended full-color image are formed on the surface of the intermediate transfer belt 11. In the course of the first-color to fourth-color primary transfer, a secondary transfer charging member (secondary transfer charging roller) 6s and a charge providing member (charge providing roller) 7r stand separate from the surface of the intermediate transfer belt 11.

The synthesized toner images formed on the surface of the intermediate transfer belt 11 are successively secondarily transferred on to a transfer material (such as paper) P by the aid of a secondary transfer bias applied from the secondary transfer charging member 6s; the transfer material P being taken out and fed from a transfer material feeding means (not shown) to the part (contact zone) between the secondary transfer opposing roller 13/intermediate transfer belt 11 and the secondary transfer member 6s in the manner synchronized with the rotation of the intermediate transfer belt 11.

The transfer material P to which the synthesized toner images have been transferred is separated from the surface of the intermediate transfer belt 11 and guided into a fixing means 8, where the synthesized toner images are fixed, and is then put out of the apparatus as a color image-formed material (a print or a copy).

The charge providing member 7r is brought into contact with the surface of the intermediate transfer belt 11 from which the synthesized toner images have been transferred. The charge providing member 7r provides the secondary transfer residual developers (toners) held on the surface of the intermediate transfer belt 11, with electric charges having a polarity reverse to that at the time of primary transfer. The secondary transfer residual developers (toners) having been provided with electric charges having the polarity reverse to that at the time of primary transfer are electrostatically transferred to the surface of the electrophotographic photosensitive member 1 at the contact zone between the electrophotographic photosensitive member 1 and the intermediate transfer belt 11 and the vicinity thereof. Thus, the surface of the intermediate transfer belt 11 from which the synthesized toner images have been transferred is cleaned by the removal of the secondary transfer residual developers (toners). The secondary transfer residual developers (toners) having been transferred to the surface of the electrophotographic photosensitive member 1 are removed by the cleaning member 7 together with the primary transfer residual developers (toners) held on the surface of the electrophotographic photosensitive member 1. The transfer of the secondary transfer residual developers (toners) from the intermediate transfer belt 11 to the electrophotographic photosensitive member 1 can be performed simultaneously with the primary transfer, and hence the though-put does not lower.

The surface of the electrophotographic photosensitive member 1 from which the transfer residual developers (toners) have been removed by the cleaning member 7 may also be subjected to charge elimination by pre-exposure light emitted from a pre-exposure means. However, where as shown in FIG. 4 contact charging making use of a roller-shaped primary charging member (a primary charging roller) or the like is employed in the charging of the surface of the electrophotographic photosensitive member, the pre-exposure is not necessarily required.

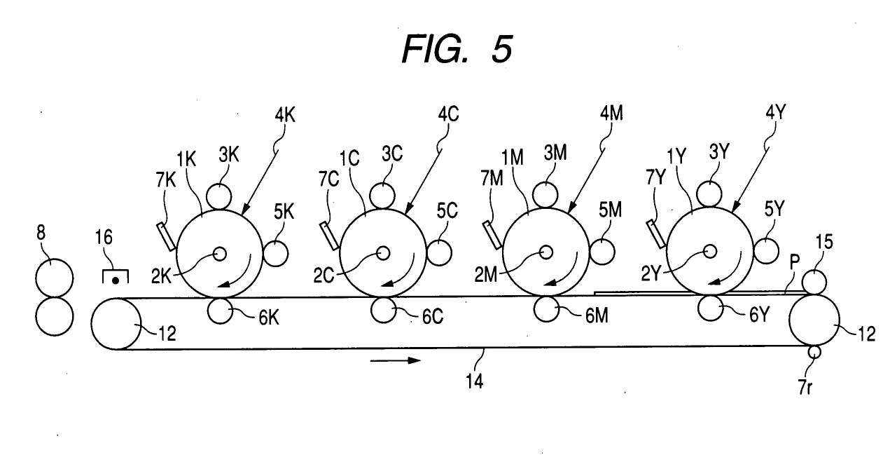

FIG. 5 schematically illustrates an example of the construction of a color electrophotographic apparatus of an in-line system. The transfer of toner images from an electrophotographic photosensitive member to a transfer material is chiefly performed by a transfer material transport belt and a transfer charging member.

In FIG. 5, reference numerals 1Y, 1M, 1C and 1K denote cylindrical electrophotographic photosensitive members (electrophotographic photosensitive members for first color to fourth color), which are rotatingly driven around axes 2Y, 2M, 2C and 2K, respectively, in the directions of arrows at a stated peripheral speed each.

The surface of the electrophotographic photosensitive member 1Y for first color which is rotatingly driven is uniformly electrostatically charged to a positive or negative, given potential through a primary charging member 3Y for first color. The electrophotographic photosensitive member thus charged is then exposed to exposure light (imagewise exposure light) 4Y emitted from an exposure means (not shown) for slit exposure, laser beam scanning exposure or the like. The exposure light 4Y is exposure light corresponding to a first-color component image (e.g., a yellow component image) of an intended color image. In this way, first-color component electrostatic latent images (yellow component electrostatic latent images) corresponding to the first-color component image of the intended color image are successively formed on the surface of the electrophotographic photosensitive member 1Y.

A transfer material transport belt 14 stretched by stretch-over rollers 12 are rotatingly driven in the direction of an arrow at substantially the same peripheral speed as the electrophotographic photosensitive members 1Y, 1M, 1C and 1K for first color to fourth color (e.g., 97% to 103% in respect to the peripheral speed of each of the electrophotographic photosensitive members 1Y, 1M, 1C and 1K for first color to fourth color). Also, a transfer material (such as paper) P fed from a transfer material feed means (not shown) is electrostatically held on (attracted to) the transfer material transport belt 14, and is successively transported to the parts (contact zones) between the electrophotographic photosensitive members 1Y, 1M, 1C and 1K for first color to fourth color and the transfer material transport belt.

The first-color component electrostatic latent images thus formed on the surface of the electrophotographic photosensitive member 1Y for first color are developed with a first-color toner contained in a developer held by a developer carrying member 5Y for first color to form first-color toner images (yellow toner images). Then, the first-color toner images thus formed and held on the surface of the electrophotographic photosensitive member 1Y for first color are successively transferred by the aid of a transfer bias applied from a transfer charging member 6Y for first color (transfer charging roller for first color), which are transferred on to a transfer material P held on the transfer material transport belt 14 which passes through between the electrophotographic photosensitive member 1Y for first color and the transfer member 6Y for first color.

The surface of the electrophotographic photosensitive member 1Y for first color from which the first-color toner images have been transferred is brought to removal of the transfer residual developer (toner) through a cleaning member 7Y for first color (cleaning blade for first color). Thus, the surface is cleaned, and thereafter the electrophotographic photosensitive member 1Y for first color is repeatedly used for the formation of the first-color toner images.

The electrophotographic photosensitive member 1Y for first color, the primary charging member 3Y for first color, the exposure means for first color, the developer carrying member 5Y for first color and the transfer charging member 6Y for first color are collectively called an image forming section for first color.

An image forming section for second color which has an electrophotographic photosensitive member 1M for second color, a primary charging member 3M for second color, an exposure means for second color, a developer carrying member 5M for second color and a transfer charging member 6M for second color, an image forming section for third color which has an electrophotographic photosensitive member 1C for third color, a primary charging member 3C for third color, an exposure means for third color, a developer carrying member 5C for third color and a transfer charging member 6C for third color, and an image forming section for fourth color which has an electrophotographic photosensitive member 1K for fourth color, a primary charging member 3K for fourth color, an exposure means for fourth color, a developer carrying member 5K for fourth color and a transfer charging member 6K for fourth color are operated in the same way as the operation of the image forming section for first color. Thus, second-color toner images (magenta toner images), third-color toner images (cyan toner images) and fourth-color toner images (black toner images) are transferred on in order, to the transfer material P which is held on the transfer material transport belt 14 and to which the first-color toner images have been transferred. In this way, synthesized toner images corresponding to the intended color image are formed on the transfer material P held on the transfer material transport belt 14.

The transfer material P on which the synthesized toner images have been formed is separated from the surface of the transfer material transport belt 14, is guided into a fixing means 8, where the toner images are fixed, and is then put out of the apparatus as a color-image-formed material (a print or a copy).

The surfaces of the electrophotographic photosensitive members 1Y, 1M, 1C and 1K for first color to fourth color from which the transfer residual developers (toners) have been removed by the cleaning members 7Y, 7M, 7C and 7K, respectively, may also be subjected to charge elimination by pre-exposure light emitted from pre-exposure means. However, where as shown in FIG. 5 contact charging making use of a roller-shaped primary charging member (a primary charging roller) or the like is employed in the charging of the surface of each electrophotographic photosensitive member, the pre-exposure is not necessarily required.

Incidentally, in FIG. 5, reference numeral 15 denotes an attraction roller for attracting the transfer material to the transfer material transport belt; and 16, a separation charging assembly for separating the transfer material from the transfer material transport belt.

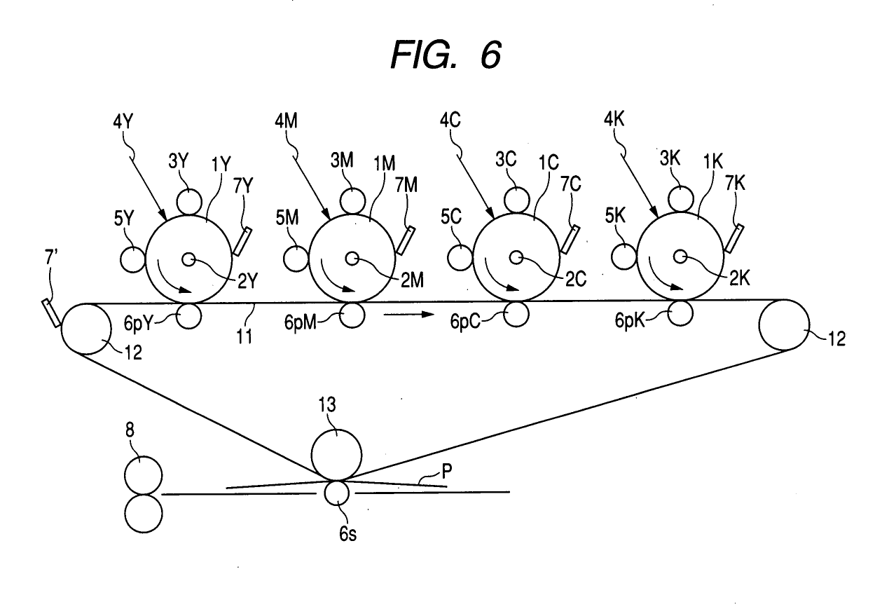

FIG. 6 schematically illustrates another example of the construction of a color electrophotographic apparatus of an intermediate transfer system. In the case of this intermediate transfer system, the transfer of toner images from an electrophotographic photosensitive member to a transfer material is chiefly performed by a primary transfer charging member, an intermediate transfer belt and a secondary transfer charging member.

In FIG. 6, reference numerals 1Y, 1M, 1C and 1K denote cylindrical electrophotographic photosensitive members (electrophotographic photosensitive members for first color to fourth color), which are rotatingly driven around axes 2Y, 2M, 2C and 2K, respectively, in the directions of arrows at a stated peripheral speed each.

The surface of the electrophotographic photosensitive member 1Y for first color which is rotatingly driven is uniformly electrostatically charged to a positive or negative, given potential through a primary charging member 13Y for first color. The electrophotographic photosensitive member thus charged is then exposed to exposure light (imagewise exposure light) 4Y emitted from an exposure means (not shown) for slit exposure, laser beam scanning exposure or the like. The exposure light 4Y is exposure light corresponding to a first-color component image (e.g., a yellow component image) of an intended color image. In this way, first-color component electrostatic latent images (yellow component electrostatic latent images) corresponding to the first-color component image of the intended color image are successively formed on the surface of the electrophotographic photosensitive member 1Y.

An intermediate transfer belt 11 stretched over stretch-over rollers 12 and a secondary transfer opposing roller 13 are rotatingly driven in the direction of an arrow at substantially the same peripheral speed as the electrophotographic photosensitive members 1Y, 1M, 1C and 1K for first color to fourth color (e.g., 97% to 103% in respect to the peripheral speed of each of the electrophotographic photosensitive members 1Y, 1M, 1C and 1K for first color to fourth color).

The first-color component electrostatic latent images thus formed on the surface of the electrophotographic photosensitive member 1Y for first color are developed with a first-color toner contained in a developer held on a developer carrying member 5Y for first color to form first-color toner images (yellow toner images). Then, the first-color toner images thus formed and held on the surface of the electrophotographic photosensitive member 1Y for first color are successively primarily transferred by the aid of a primary transfer bias applied from a primary transfer charging member 6pY for first color (primary transfer charging roller for first color), which are transferred on to the surface of an intermediate transfer belt 11 which passes the part between the electrophotographic photosensitive member 1Y for first color and the primary transfer member 6pY for first color.

The surface of the electrophotographic photosensitive member 1Y for first color from which the first-color toner images have been transferred is brought to removal of the transfer residual developer (toner) through a cleaning member 7Y for first color (cleaning blade for first color). Thus, the surface is cleaned, and thereafter the electrophotographic photosensitive member 1Y for first color is repeatedly used for the formation of the first-color toner images.

The electrophotographic photosensitive member 1Y for first color, the primary charging member 3Y for first color, the exposure means for first color, the developer carrying member 5Y for first color and the transfer charging member 6pY for first color are collectively called an image forming section for first color.

An image forming section for second color which has an electrophotographic photosensitive member 1M for second color, a primary charging member 3M for second color, an exposure means for second color, a developer carrying member 5M for second color and a primary transfer charging member 6pM for second color, an image forming section for third color which has an electrophotographic photosensitive member 1C for third color, a primary charging member 3C for third color, an exposure means for third color, a developer carrying member 5C for third color and a primary transfer charging member 6pC for third color, and an image forming section for fourth color which has an electrophotographic photosensitive member 1K for fourth color, a primary charging member 3K for fourth color, an exposure means for fourth color, a developer carrying member 5K for fourth color and a primary transfer charging member 6pK for fourth color are operated in the same way as the operation of the image forming section for first color. Thus, second-color toner images (magenta toner images), third-color toner images (cyan toner images) and fourth-color toner images (black toner images) are transferred on in order, to the surface of the intermediate transfer belt 11. In this way, synthesized toner images corresponding to the intended color image are formed on the surface of the intermediate transfer belt 11.

The synthesized toner images formed on the surface of the intermediate transfer belt 11 are successively secondarily transferred on to a transfer material (such as paper) P by the aid of a secondary transfer bias applied from a secondary transfer charging member 6s; the transfer material P being taken out and fed from a transfer material feeding means (not shown) to the part (contact zone) between the secondary transfer opposing roller 13/intermediate transfer belt 11 and the secondary transfer member 6s in the manner synchronized with the rotation of the intermediate transfer belt 11.

The transfer material P to which the synthesized toner images have been transferred is separated from the surface of the intermediate transfer belt 11, is guided into a fixing means 8, where the toner images are fixed, and is then put out of the apparatus as a color-image-formed material (a print or a copy).

The surface of the intermediate transfer belt 11 from which the synthesized toner images have been transferred is brought to the removal of secondary transfer residual developers (toners) through an intermediate transfer belt cleaning member 7′. Thus, its surface is cleaned, and thereafter the intermediate transfer belt 11 is repeatedly used for the formation of the synthesized toner images.

The surfaces of the electrophotographic photosensitive members 1Y, 1M, 1C and 1K for first color to fourth color from which the transfer residual developers (toners) have been removed by the cleaning members 7Y, 7M, 7C and 7K, respectively, may also be subjected to charge elimination by pre-exposure light emitted from pre-exposure means. However, where as shown in FIG. 6 contact charging making use of a roller-shaped primary charging member (a primary charging roller) or the like is employed in the charging of the surface of each electrophotographic photosensitive member, the pre-exposure is not necessarily required.

Besides the intermediate transfer belt or the transfer material transporting belt, the electrophotographic endless belt of the present invention is applicable to the whole field of endless belts used in electrophotographic apparatus, such as a photosensitive belt, a transfer belt, transporting belts other than the transfer material transporting belt, a developing belt, a charging belt and a paper feed belt. It may particularly preferably be used as the intermediate transfer member and transfer material transporting member described above.

The electrophotographic endless belt of the present invention may also be set in the main body of the electrophotographic apparatus as it is, or may be used as an endless belt cartridge in the form that it is detachably mountable to the main body of the electrophotographic apparatus. For example, a process cartridge may be set up in which the electrophotographic endless belt of the present invention and electrophotographic process members such as the electrophotographic photosensitive member and the primary charging member are set integral.

### EXAMPLES

The present invention is described below in greater details by giving specific working examples. The present invention is by no means limited to these. In the following Examples, “part(s)” refers to “part(s) by weight”.

Methods for evaluation and for measuring volume resistivity of electrophotographic endless belts in Examples are described below.

How to Measure Volume Resistivity of Electrophotographic Endless Belt

Measuring Instrument
Resistance meter: Ultra-high resistance meter R8340A (manufactured by Advantest Corporation).
Sample box: Sample box TR42 for ultra-high resistance meter (manufactured by Advantest Corporation).

The main electrode is 25 mm in diameter, and the guard-ring electrode is 41 mm in inner diameter and 49 mm in outer diameter.

Sample

The electrophotographic endless belt (transfer material transporting belt) is cut in a circular form of 56 mm in diameter. After cutting, it is provided, on its one side, with an electrode over the whole surface by forming a Pt—Pd deposited film and, on the other side, provided with a main electrode of 25 mm in diameter and a guard electrode of 38 mm in inner diameter and 50 mm in outer diameter by forming Pt—Pd deposited films (according to ASTM D257-789). The Pt—Pd deposited films are formed by carrying out vacuum deposition for 2 minutes using MILD SPUTTER E1030 (manufactured by Hitachi Ltd.), setting at about 15 mm the distance between a deposition object and a Pt—Pd target and at an electric current of 15 mA. The one on which the vacuum deposition has been carried out is used as a measuring sample.

Measurement Conditions
Measurement atmosphere: 23° C./55% RH(N/N: normal temperature/normal humidity).

Here, the measuring sample is previously kept left in a environment of 23° C./55% RH for 12 hours or more.
Measurement mode: Discharge for 10 seconds, and charge and measurement for 30 seconds.
Applied voltage: 100 V.

As the applied voltage, employed is 100 V in 1 to 1,000 V which is the range of the voltage applied usually to the electrophotographic endless belt in the electrophotographic apparatus.

Evaluation on Leak

Evaluation Instrument and How to Evaluate Leak

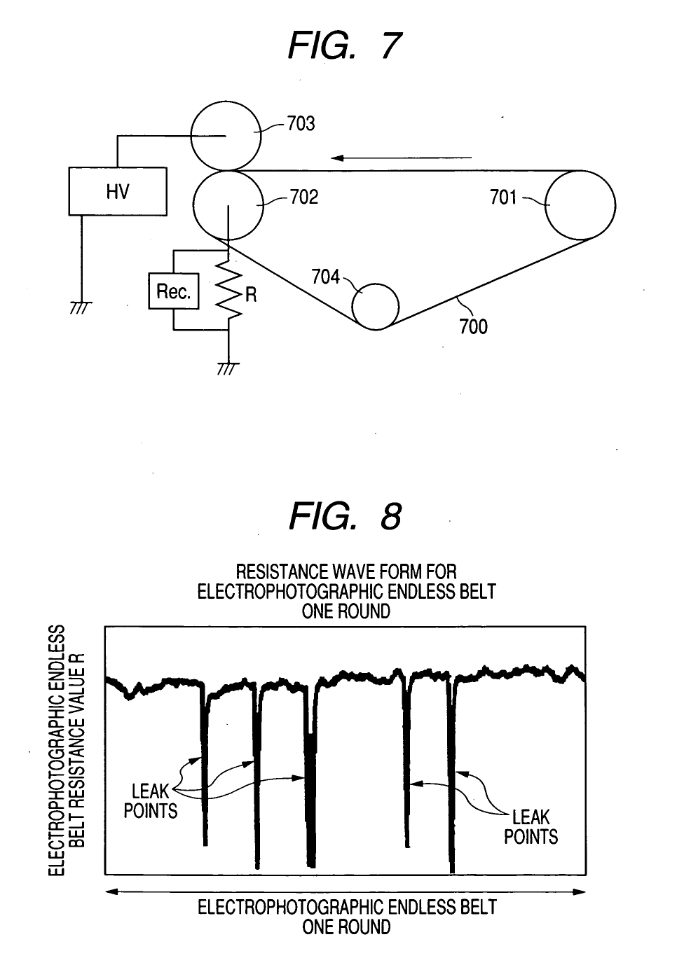

How to ascertain whether or not leak points are present in the electrophotographic endless belt in the present invention is described below with reference to FIG. 7.

An electrical property measuring instrument set up as shown in FIG. 7 is used as a measuring instrument.

In FIG. 7, an endless belt 700 is stretched over a drive roller 701 (made of rubber of 60 degrees in JIS A hardness; diameter: 30 mm), an electrode roller 702 (made of aluminum; diameter: 30 mm) and a tension roller 704 (made of aluminum; diameter: 20 mm; tension load: 50 N). Also, an electric-power supply roller 703 is kept in contact with the electrode roller 702 at a force of 20 N (per 300 mm in width). The electric-power supply roller 703 is a rubber roller having sufficiently low resistance (about 1×10⁶ Ωcm) with respect to the belt whose resistance is to be measured, and is 60 degrees in JIS A hardness and 30 mm in diameter.

The endless belt 700 is driven by the drive roller 701 in the direction of an arrow at a speed of 100 mm/s, and a voltage of +300 V is applied to the electric-power supply roller 703 from a high-voltage power source HV (e.g., MODEL 610C, manufactured by TReK Co.). A resistor R having a known electrical resistance value (e.g., 1 kΩ) is connected across the electrode roller 702 and the ground, and potential difference at both ends of this resistor R is recorded on a recorder Rec. (e.g., an oscillographic recorder ORM1200, manufactured by Yokogawa Electric Corporation). The electric current passed across the electric-power supply roller 703 and the electrode roller 702 (equal to the electric current passed through the resistor R) is calculated from the potential difference at both ends of the resistor R and the resistance value of the resistor R. From the electric current value thus calculated and the applied voltage 300 V, the resistance value of the endless belt is found by calculation.

Here, a sample rate of the recorder Rec. is set at 100 Hz, and the resistance value for belt one round is measured, and data for the one round are graphed to ascertain whether or not leaks (portions having an extremely low resistance than surroundings) are present. Where the leaks are present, sharp peaks appear as shown in FIG. 8. In FIG. 8, leak points are seen at five points per one round of the electrophotographic endless belt.

Evaluation Criteria on Leak
AA: The number of leak points is 0.
A: The number of leak points is 1 to 3.
B: The number of leak points is 4 to 10.
C: The number of leak points is more than 10.

Evaluation of Flexing Resistance

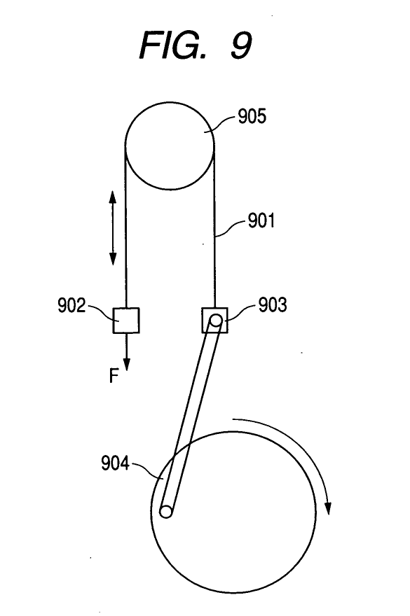

The flexing resistance (not to easily cause cracking or break) is evaluated using a flexing tester set up as shown in FIG. 9.

Evaluation Instrument and How to Evaluate Flexing Resistance

The electrophotographic endless belt is cut in a strip of 20 mm in width and 200 mm in length (where the electrophotographic endless belt has a thickness of 100 μm). This strip-shaped sample 901 is set on chucks 902 and 903 of the flexing tester. The chuck 903 is connected to the crank 904 side, and a load (F) is applied to the chuck 902 (the load or sample width is so adjusted that the stress applied is 19.6 MPa). Driving the crank 904 (rotating a disk in the direction of an arrow) makes the strip-shaped sample 901 move reciporocally over a roller (free rotatable) 905 to make it bend and stretch repeatedly.

Through this test, a stress more than that which the electrophotographic endless belt receives actually in the electrophotographic apparatus can be applied to the sample.

The roller 905 is 10 mm in diameter and 20 mm in movement stroke, and is movable at a speed of 0.5 second per one reciprocation.

Evaluation Criteria on Flexing Resistance

In the flexing resistance evaluation test, a sample which did neither crack nor break even as a result of 1,000,000-time reciprocation is evaluated as “A”, a sample which cracked or broke during 500,000-time to 1,000,000-time reciprocation as “B”, and a sample which cracked or broke upon less than 500,000-time reciprocation as “C”.

Evaluation of Images Reproduced

How to Evaluate Initial-Stage Images Reproduced

Electrophotographic endless belts produced in Examples and Comparative Examples are each set as the transfer material transporting member or the intermediate transfer member in the electrophotographic apparatus, and full-color images are reproduced to evaluate the quality level of images obtained.

How to Evaluate Images Reproduced after Image Reproduction Running Test

After the initial-stage images reproduced have been evaluated, a 10,000-sheet image reproduction running test is conducted to evaluate the quality level of images obtained after the running test.

Evaluation Criteria on Images Reproduced
A: Good images have been obtained.
B: Approximately good images have been obtained (slightly faulty images are seen).
C: Inferior to A and B.

Evaluation of Creep Resistance

How to Evaluate Creep Resistance

The peripheral length (L₀) of each endless belt before the image reproduction running test is beforehand measured. Thereafter, a 10,000-sheet image reproduction running test is conducted, and the peripheral length (L₁) of each endless belt after the image reproduction running test is measured. Creep rate is calculated according to the following expression.
Creep rate (%)=(L₁−L₀)/L₀×100.

Evaluation Criteria on Creep Resistance:
A: Creep rate is less than 1%.
B: Creep rate is 1 to 3%.
C: Creep rate is more than 3%.

### Example 1

An electrophotographic endless belt was produced using the following materials.

| | |
|---|---|
| Polyamide 610 | 57 parts |
| Polyamide 12 | 14 parts |
| Copper(I) iodide | 0.3 part |
| Carbon black (DENKA BLACK powdery product) | 10 parts |
| Polyether ester amide resin | 2 parts |
| Potassium perfluorobutanesulfonate | 3 parts |
| Zinc oxide, 1st class | 13.6 parts |
| Dispersing agent | 0.1 part |
| (CHIRABAZOL H818, available from Taiyo | |
| Kagaku Co., Ltd.) | |

The polyamide resins, the copper(I) iodide, the polyether ester amide resin and the potassium perfluorobutanesulfonate were mixed by means of a tumbling mixer (this is designated as Mixture A).

Separately, the carbon black and the dispersing agent were also mixed by means of Henschel mixer.

Next, in the apparatus set up as shown in FIG. 3, Mixture A was introduced into the twin-screw extruder 301 from the hopper 302. At the stage the resin melted, the zinc oxide and the carbon black having beforehand been mixed with the dispersing agent was introduced into the twin-screw extruder 301 from the hopper 302′.

The above materials having been melt-kneaded (kneading temperature: 250° C.) by means of the twin-screw extruder 301 were extruded from the strand die 303 in the form of the strand 304 (2 mm in diameter), which was then passed through the water bath 305 so as to be cooled, and then passed through the strand cutter 306 to obtain an extrusion material.

Next, in the apparatus set up as shown in FIG. 1, the extrusion material was introduced into the hopper 102 installed to the extruder 101, and the blown-film extrusion described previously was carried out to obtain a tube.

With this tube, a both-end hermetically closed PFA (perfluoroalkoxyl resin) tube of 150 mm in outer diameter was covered on its outer peripheral surface.

Next, this was further covered thereon with a nickel electroformed sleeve of 154 mm in inner diameter, 320 mm in length and 0.5 mm in wall thickness, where compressed air of 0.4 MPa was fed from the inside of the PFA tube to make the PFA tube inflate. Thus, the tube obtained by the blown-film extrusion was sandwiched between the PFA tube (inner peripheral surface) and the nickel electroformed sleeve (outer peripheral surface).

In this state, heat of a halogen heater was applied to the nickel electroformed sleeve to heat the nickel electroformed sleeve. Thereafter, the nickel electroformed sleeve was cooled to room temperature, and the compressed air having been fed to the inside of the PFA tube was let out to release the sandwiching.

After the release, the blown-film extruded tube was taken out, where its folds were seen to have disappeared. This was because the blown-film extruded tube came into a molten state or a semi-molten state when the nickel electroformed sleeve was heated.

Next, both edges of the endless belt whose folds were removed, surface smoothness was adjusted and size was adjusted through the above step were precisely cut to obtain an electrophotographic endless belt of 480 mm in peripheral length, 250 mm in width and 100 μm in thickness.

A meandering preventive member was also attached to the back of this electrophotographic endless belt.

This electrophotographic endless belt had a volume resistivity of 1×10¹¹ Ωcm.

Evaluation was made on the leak of the electrophotographic endless belt produced, to find that the leak was at the rank “AA” in the above criteria.

The flexing resistance of the electrophotographic endless belt obtained was also evaluated to find that it was at the rank “A” in the above criteria.

The electrophotographic endless belt obtained was also set as a transfer material transporting belt in the electrophotographic apparatus (color laser printer) set up as shown in FIG. 5, and full-color images were reproduced to evaluate the initial-stage images reproduced, to find that the images were at the rank “A” in the above criteria.

After the evaluation of the initial-stage images reproduced, the 10,000-sheet image reproduction running test was conducted to evaluate the quality level of images obtained after the running test, to find that the images were at the rank “A” in the above criteria. The creep resistance was also evaluated to find that it was at the rank “A” in the above criteria. Also, neither crack nor break was seen.

The results of measurement and the results of evaluation are shown in Table 1.

### Examples 2 to 19

Electrophotographic endless belts were produced in the same manner as in Example 1 except that the materials used to produce the electrophotographic endless belt were changed as shown in Tables 1 to 3, provided that the kneading temperature was set at 280° C. in Example 16, at 300° C. in Example 17, and at 320° C. in Examples 18 and 19.

The measurement of volume resistivity and evaluation of the electrophotographic endless belts produced were made in the same manner as in Example 1.

The results of measurement and the results of evaluation are shown in Tables 1 to 3.

### Examples 20 and 21

Electrophotographic endless belts were produced in the same manner as in Example 1 except that the materials used to produce the electrophotographic endless belt were changed as shown in Table 3 and that the electrophotographic endless belts produced were each in a size of 440 mm in peripheral length, 240 mm in width and 100 μm in thickness.

The volume resistivity of the electrophotographic endless belts produced was measured in the same manner as in Example 1.

The electrophotographic endless belts produced were evaluated in the same manner as in Example 1 except that the electrophotographic apparatus in which the electrophotographic endless belt was set was changed for the electrophotographic apparatus (color laser printer) set up as shown in FIG. 4 (the endless belt was used as an intermediate transfer belt).

The results of measurement and the results of evaluation are shown in Table 3.

### Examples 22

An electrophotographic endless belt was produced in the same manner as in Example 1 except that the materials used to produce the electrophotographic endless belt were changed as shown in Table 3 and that the electrophotographic endless belt produced was in a size of 700 mm in peripheral length, 260 mm in width and 100 μm in thickness.

The volume resistivity of the electrophotographic endless belt produced was measured in the same manner as in Example 1.

The electrophotographic endless belts produced were evaluated in the same manner as in Example 1 except that the electrophotographic apparatus in which the electrophotographic endless belt was set was changed for the electrophotographic apparatus (color laser printer) set up as shown in FIG. 6 (the endless belt was used as an intermediate transfer belt).

The results of measurement and the results of evaluation are shown in Table 3.

### Comparative Examples 1 to 5

Electrophotographic endless belts were produced in the same manner as in Example 1 except that the materials used to produce the electrophotographic endless belt were changed as shown in Table 4.

The volume resistivity of the electrophotographic endless belts produced was measured in the same manner as in Example 1.

The electrophotographic endless belt produced in Comparative Example 3 was evaluated in the same manner as in Example 1. Also, the electrophotographic endless belts produced in Comparative Examples 1 and 2 caused many image defects due to leak, in images reproduced at the initial stage, and also showed an inferior flexing resistance. Accordingly, the image reproduction running test was not conducted, but other evaluation was made in the same manner as in Example 1. Also, the electrophotographic endless belt produced in Comparative Example 4 had too small volume resistivity to attract transfer materials (paper) sufficiently, so that images with great color misregistration were formed from the beginning. Accordingly, the image reproduction running test was not conducted, but other evaluation was made in the same manner as in Example 1. Still also, the electrophotographic endless belt produced in Comparative Example 5 had so large volume resistivity that polka-dot images were formed because of abnormal discharge at the time of transfer. Accordingly, the image reproduction running test was not conducted, but other evaluation was made in the same manner as in Example 1.

The results of measurement and the results of evaluation are shown in Table 4.

TABLE 1

| | Example | | | | | | | |
|---|---|---|---|---|---|---|---|---|
| Materials [part(s)] | 1 | 2 | 3 | 4 | 5 | 6 | 7 | 8 |
| PA12 | 14 | 34.87 | — | 22.2 | — | 74 | 98.5 | — |
| PA11 | — | — | — | — | — | — | — | 33 |
| PA612 | — | — | — | — | 74 | — | — | 49 |
| PA610 | 57 | 53 | 86 | 51.8 | — | — | — | — |
| PA6 | — | — | — | — | — | — | — | — |
| PA MXD6 | — | — | — | — | — | — | — | — |
| PA66 | — | — | — | — | — | — | — | — |
| PA46 | — | — | — | — | — | — | — | — |
| PA 9T | — | — | — | — | — | — | — | — |
| PA 6T | — | — | — | — | — | — | — | — |
| Acrylic resin | — | — | — | — | — | — | — | — |
| Copper(I) iodide | 0.3 | 0.01 | 1 | 0.005 | 1.5 | — | 1.5 | — |
| Potassium iodide | — | — | — | — | — | 0.3 | — | — |
| Copper(I) chloride | — | — | — | — | — | — | — | 0.15 |
| Potassium chloride | — | — | — | — | — | — | — | — |
| IRGANOX 245 | — | — | — | — | — | — | — | — |
| DENKA BLACK powdery product | 10 | 12 | — | 10 | 12 | 12 | — | 10.5 |
| KETJEN BLACK EC600JD | — | — | 3 | — | — | — | — | — |
| PEEA | 2 | — | 10 | — | — | — | — | 2 |
| KFBS | 3 | — | — | — | — | — | — | 0.5 |
| ZnO | 13.6 | — | — | 15.9 | — | 13.58 | — | — |
| Talc | — | — | — | — | 12.5 | — | — | — |
| Silica | — | — | — | — | — | — | — | — |
| BF-E | — | — | — | — | — | — | — | 4.85 |
| MAH-PE | — | — | — | — | — | — | — | — |
| PAE | — | — | — | — | — | — | — | — |
| CHIRABAZOL H-818 | 0.1 | 0.12 | — | 0.1 | — | 0.12 | — | — |
| CHIRABAZOL P-4 | — | — | — | — | — | — | — | — |
| Melamine cyanurate | — | — | — | — | — | — | — | — |
| Phosphate | — | — | — | — | — | — | — | — |
| Total | 100 | 100 | 100 | 100 | 100 | 100 | 100 | 100 |
| Type of belt: | ETB | ETB | ETB | ETB | ETB | ETB | ETB | ETB |
| Volume resistivity: (Ωcm) | 1 × 10¹¹ | 1 × 10¹⁰ | 8 × 10⁹ | 4 × 10¹¹ | 3 × 10¹¹ | 2 × 10¹⁰ | 9 × 10¹¹ | 5 × 10¹¹ |
| Evaluation | | | | | | | | |
| Leak: | AA | A | AA | B | B | A | A | AA |
| Initial-stage images reproduced: | A | A | A | B | B | A | A | A |
| Images reproduced after | A | A | A | B | B | A | A | A |
| image reproduction running test: | | | | | | | | |
| Flexing resistance: | A | A | A | A | B | A | A | A |
| Creep resistance: | A | A | A | B | A | A | B | A |

TABLE 2

| | Example | | | | | | | |
|---|---|---|---|---|---|---|---|---|
| Materials [part(s)] | 9 | 10 | 11 | 12 | 13 | 14 | 15 | 16 |
| PA12 | 30 | 59.6 | 37 | 74 | — | — | — | — |
| PA11 | — | — | — | — | 74 | — | — | — |
| PA612 | — | — | 37 | — | — | — | — | — |
| PA610 | 44 | — | — | — | — | — | — | — |
| PA6 | — | — | — | — | — | 74 | — | — |
| PA MXD6 | — | — | — | — | — | — | 74 | — |
| PA66 | — | — | — | — | — | — | — | 74 |
| PA46 | — | — | — | — | — | — | — | — |
| PA 9T | — | — | — | — | — | — | — | — |
| PA 6T | — | — | — | — | — | — | — | — |
| Acrylic resin | — | — | — | — | — | — | — | — |
| Copper(I) iodide | 0.1 | 0.3 | 0.3 | 0.2 | — | — | — | 0.15 |
| Potassium iodide | — | — | — | 0.3 | — | — | — | 0.15 |
| Copper(I) chloride | — | — | — | — | 0.5 | — | 0.15 | — |
| Potassium chloride | — | — | — | — | — | 0.5 | 0.15 | — |
| IRGANOX 245 | — | — | — | — | — | — | — | — |
| DENKA BLACK powdery product | 10 | 9 | 12 | — | — | 11 | 11 | 11 |
| KETJEN BLACK EC600JD | — | — | 3.5 | 3.5 | — | — | — | — |
| PEEA | — | — | — | — | — | — | — | — |
| KFBS | — | — | — | — | — | — | — | — |
| ZnO | — | 16 | 13.58 | — | — | — | 14.59 | 14.59 |
| Talc | 7.8 | — | — | — | — | 14.39 | — | — |
| Silica | 3 | — | — | 2 | 2 | — | — | — |
| BF-E | — | — | — | — | — | — | — | — |
| MAH-P | 5 | — | — | — | — | — | — | — |
| PAE | — | 15 | — | — | — | — | — | — |
| CHIRABAZOL H-818 | 0.1 | 0.1 | — | — | — | 0.11 | 0.11 | 0.11 |
| CHIRABAZOL P-4 | — | — | 0.12 | — | — | — | — | — |
| Melamine cyanurate | — | — | — | 20 | — | — | — | — |
| Phosphate | — | — | — | — | 20 | — | — | — |
| Total | 100 | 100 | 100 | 100 | 100 | 100 | 100 | 100 |
| Type of belt: | ETB | ETB | ETB | ETB | ETB | ETB | ETB | ETB |
| Volume resistivity: (Ωcm) | 1 × 10¹¹ | 9 × 10⁹ | 7 × 10¹⁰ | 6 × 10¹⁰ | 8 × 10¹⁰ | 5 × 10¹⁰ | 4 × 10¹⁰ | 1 × 10¹¹ |
| Evaluation | | | | | | | | |
| Leak: | AA | A | A | A | A | A | A | A |
| Initial-stage images reproduced: | A | A | A | A | A | A | A | A |
| Images reproduced after | A | A | A | A | A | A | A | A |
| image reproduction running test: | | | | | | | | |
| Flexing resistance: | A | A | A | A | A | A | A | A |
| Creep resistance: | A | B | A | A | A | A | A | A |

TABLE 3

| | Example | | | | | |
|---|---|---|---|---|---|---|
| Materials [part(s)] | 17 | 18 | 19 | 20 | 21 | 22 |
| PA12 | — | — | — | 49 | 57 | 74 |
| PA11 | — | — | — | — | — | — |
| PA612 | — | — | — | — | — | — |
| PA610 | — | — | — | — | 14 | — |
| PA6 | — | — | — | — | — | — |
| PA MXD6 | — | — | — | — | — | — |
| PA66 | — | — | — | — | — | — |
| PA46 | 74 | — | — | — | — | — |
| PA 9T | — | 74 | — | — | — | — |
| PA 6T | — | — | 74 | — | — | — |
| Acrylic resin | — | — | — | — | — | — |
| Copper(I) iodide | — | 0.2 | 0.1 | — | 0.3 | 0.3 |
| Potassium iodide | 0.2 | — | 0.1 | 0.25 | — | — |
| Copper(I) chloride | 0.2 | — | 0.1 | — | — | — |
| Potassium chloride | — | 0.2 | 0.1 | — | — | — |
| IRGANOX 245 | — | — | — | — | — | — |
| DENKA BLACK powdery product | 11 | 11 | — | — | 11 | 12 |
| KETJEN BLACK EC600JD | — | — | 3.5 | — | — | — |
| PEEA | — | — | — | 25 | 2 | — |
| PEEA | — | — | — | 3 | 2 | — |
| ZnO | — | 14.49 | 22.1 | 22.75 | 13.59 | — |
| Talc | 14.49 | — | — | — | — | 13.58 |
| Silica | — | — | — | — | — | — |
| BF-E | — | — | — | — | — | — |
| MAH-PE | — | — | — | — | — | — |
| PAE | — | — | — | — | — | — |
| CHIRABAZOL H-818 | 0.11 | 0.11 | — | — | 0.11 | 0.12 |
| CHIRABAZOL P-4 | — | — | — | — | — | — |
| Melamine cyanurate | — | — | — | — | — | — |
| Phosphate | — | — | — | — | — | — |
| Total | 100 | 100 | 100 | 100 | 100 | 100 |
| Type of belt: | ETB | ETB | ETB | ITB | ITB | ITB |
| Volume resistivity: (Ωcm) | 9 × 10⁹ | 8 × 10¹⁰ | 7 × 10¹⁰ | 6 × 10⁹ | 1 × 10¹⁰ | 5 × 10¹⁰ |
| Evaluation | | | | | | |
| Leak: | A | A | A | AA | AA | AA |
| Initial-stage images reproduced: | A | A | A | A | A | A |
| Images reproduced after | A | A | A | A | A | A |
| image reproduction running test: | | | | | | |
| Flexing resistance: | A | A | A | A | A | A |
| Creep resistance: | A | A | A | B | A | A |

TABLE 4

| | Comparative Example | | | | |
|---|---|---|---|---|---|
| Materials [part(s)] | 1 | 2 | 3 | 4 | 5 |
| PA12 | — | 74 | 37 | — | — |
| PA11 | — | — | — | — | — |
| PA612 | — | — | — | — | — |
| PA610 | — | — | 37 | 74 | — |
| PA6 | — | — | — | — | 64 |
| PA MXD6 | — | — | — | — | — |
| PA66 | — | — | — | — | — |
| PA46 | — | — | — | — | — |
| PA 9T | — | — | — | — | — |
| PA 6T | — | — | — | — | — |
| Acrylic resin | 84.85 | — | — | — | — |
| Copper(I) iodide | 0.5 | — | — | 0.1 | 0.1 |
| Potassium iodide | — | — | — | — | — |
| Copper(I) chloride | — | — | — | — | — |
| Potassium chloride | — | — | — | — | — |
| IRGANOX 245 | — | — | 0.5 | — | — |
| DENKA BLACK powdery product | 14.5 | 12 | 12 | — | 6 |
| KETJEN BLACK EC600JD | — | — | — | 4 | — |
| PEEA | — | — | — | — | 10 |
| KFBS | — | — | — | — | — |
| ZnO | — | 13.88 | — | 21.9 | — |
| Talc | — | — | 13.38 | — | 19.9 |
| Silica | — | — | — | — | — |
| BF-E | — | — | — | — | — |
| MAH-PE | — | — | — | — | — |
| PAE | — | — | — | — | — |
| CHIRABAZOL H-818 | 0.15 | 0.12 | 0.12 | — | — |
| CHIRABAZOL P-4 | — | — | — | — | — |
| Melamine cyanurate | — | — | — | — | — |
| Phosphate | — | — | — | — | — |
| Total | 100 | 100 | 100 | 100 | 100 |
| Type of belt: | ETB | ETB | ETB | ETB | ETB |
| Volume resistivity: (Ωcm) | 5 × 10¹⁰ | 4 × 10¹⁰ | 2 × 10¹⁰ | 9 × 10⁵ | 2 × 10¹⁴ |
| Evaluation | | | | | |
| Leak: | C | C | B | A | A |
| Initial-stage images reproduced: | C | C | B | C | C |
| Images reproduced after | — | — | C | — | — |
| image reproduction running test: | | | | | |
| Flexing resistance: | C | C | A | B | A |
| Creep resistance: | — | — | B | — | — |

Explanation of Tables 1 and 2 is given below.

Materials
“PA”: “Polyamide”
PA12: UBE STAR 3030U, available from Ube Industries, Ltd.
PA11: RILSAN BESN-O-TL, available from Atofina Co.
PA612: DIAMID D22, available from Daicel-Degussa Ltd.
PA610: AMILAN CM2001, available from Toray Industries, Inc.
PA6: AMILAN CM1041 (LO), available from Toray Industries, Inc.
PAMXD6: MX Nylon S6121, available from Mitsubishi Gas Chemical Company, Inc.
PA66: LEONA 1700S, available from Asahi Chemical Industry Co., Ltd.
PA46: STANYL TS300, available from DJEP.
PA9T: GENESTA N1000A, available from Kuraray Co., Ltd.
PA6T: AREN AE4200, available from Mitsui Chemicals Inc.
Acrylic resin: DELPET SR6500, available from Asahi Kasei Chemicals Corporation.
Copper(I) iodide: A first-grade reagent available from Kishida Chemical Co., Ltd.
Potassium iodide: A guaranteed reagent available from Kishida Chemical Co., Ltd.
Copper(I) chloride: A guaranteed reagent available from Kishida Chemical Co., Ltd.
Potassium chloride: A guaranteed reagent available from Kishida Chemical Co., Ltd.
IRGANOX 245: Available from Ciba Specialty Chemicals. DENKA BLACK, powdery product: Available from Denki Kagaku Kogyo Kabushiki Kaisha.
KETJEN BLACK EC600JD: Available from Lion Corporation.
PEEA: Polyether ester amide (a conductive resin),
PELESTAT NC6321, available from Sanyo Chemical Industries, Ltd.
KFBS: Potassium perfluorobutanesulfonate (a conducting agent), EFTOP, available from Mitsubishi Materials Corporation.
ZnO: Zinc oxide, 1st class, available from Sakai Chemical Industry Co., Ltd.
Talc: MICROACE P-3, available from Nippon Talc Co., Ltd.
Silica: AEROSIL RY200, available from Nippon Aerosil Co., Ltd.
BF-E: Ethylene/glycidyl methacrylate copolymer (a modified polyolefin), BOND FAST E, available from Sumitomo Chemical Cp., Ltd.
MAH-PE: Maleic acid modified polyethylene (a modified polyolefin), NUC Polyethylene GA-004, available from Nippon Unicar Co., Ltd.
PAE: Polyamide elastomer (a thermoplastic elastomer), PEBAX #3533, available from Atofina Co.
H-818: Polyglycerol poly-ricinolate (a dispersing agent), CHIRABAZOL H818, available from Taiyo Kagaku Co., Ltd.
P-4: Polyglycerol stearate (a dispersing agent), CHIRABAZOL P-4, available from Taiyo Kagaku Co., Ltd. Melamine cyanurate (a flame retardant), MC-610, available from Nissan Chemical Industries, Ltd. Phosphate (a flame retardant), PX-200, available from Daihachi Chemical Industry Co., Ltd.

Type of Belt (Type of Electrophotographic Endless Belt)
ETB: Transfer material transporting belt.
ITB: Intermediate transfer belt.

As having been described above, according to the present invention, it can provide an electrophotographic endless belt having been kept from causing the cracking, breaking or creep that may occur when used repeatedly, and can provide a process for producing the electrophotographic endless belt and an electrophotographic apparatus having the electrophotographic endless belt.

This application claims priority from Japanese Patent Application No. 2004-277570 filed on Sep. 24, 2004, which is hereby incorporated by reference herein.

What is claimed is:

1. An electrophotographic endless belt comprising a polyamide resin and an additive A,
wherein said additive A is at least one selected from the group consisting of copper(I) iodide, potassium iodide, copper(I) chloride and potassium chloride, and
said electrophotographic endless belt has a volume resistivity of from 1×10⁶ to 1×10¹⁴ Ωcm.

2. The electrophotographic endless belt according to claim 1, wherein said additive A in said electrophotographic endless belt is in a content of from 0.01% by weight to 1% by weight based on the total weight of said polyamide resin and said additive A.

3. The electrophotographic endless belt according to claim 1, which further comprises a particulate conducting agent.

4. The electrophotographic endless belt according to claim 1, which further comprises polyglycerol poly-ricinolate or polyglycerol stearate.

5. The electrophotographic endless belt according to claim 3, wherein at least one of said particulate conducting agent is carbon black.

6. A process for producing an electrophotographic endless belt which comprises a polyamide resin, carbon black and an additive A comprising at least one selected from the group consisting of copper(I) iodide, potassium iodide, copper(I) chloride and potassium chloride, and has a volume resistivity of from 1×10⁶ to 1×10¹⁴ Ωcm;
said process comprising the step of mixing said polyamide resin, said carbon black and said additive A before said polyamide resin and said carbon black are compounded.

7. An electrophotographic apparatus having an electrophotographic endless belt, said electrophotographic endless belt comprising a polyamide resin and an additive A;
wherein said additive A is at least one selected from the group consisting of copper(I) iodide, potassium iodide, copper(I) chloride and potassium chloride, and
said electrophotographic endless belt has a volume resistivity of from 1×10⁶ to 1×10¹⁴ Ωcm.

8. The electrophotographic apparatus according to claim 7, wherein said electrophotographic endless belt is a transfer material transporting belt.

9. The electrophotographic apparatus according to claim 7, wherein said electrophotographic endless belt is an intermediate transfer belt.
